(19) United States
(12) Patent Application Publication
(10) Pub. No.: US 2025/0376068 A1
(43) Pub. Date: Dec. 11, 2025

(54) METHODS AND SYSTEM FOR COMMISSIONING A VEHICLE CHARGER

(71) Applicant: Ford Global Technologies, LLC, Dearborn, MI (US)

(72) Inventors: Stuart Salter, White Lake, MI (US); Michael J. Ulczynski, Wyandotte, MI (US); Kristen Johnson, Ann Arbor, MI (US); Peter J. Nikolajevs, Dearborn, MI (US); Annette Lynn Huebner, Highland, MI (US); Ryan O'Gorman, Beverly Hills, MI (US)

(21) Appl. No.: 18/739,572

(22) Filed: Jun. 11, 2024

(51) Int. Cl. B60L 53/68; B60L 53/30; B60L 53/66

(52) U.S. Cl. CPC B60L 53/68; B60L 53/66; B60L 53/305

(57) ABSTRACT

Systems and methods for commissioning a vehicle charger are described. A vehicle charger may be commissioned so that the vehicle charger may supply electric charge to a vehicle after the vehicle charger is installed. In one example, the vehicle charger may be commissioned automatically when power is applied to the vehicle charger.

### FIELD

The present description relates to methods and a system for commissioning a vehicle charger. The methods and systems may be particularly useful for bringing electric vehicle chargers into service.

### BACKGROUND

A consumer or a commercial entity may install a vehicle charger for charging an electric vehicle. The vehicle charger, or simply “charger,” may go through a commissioning process whereby features and functions of the charger are verified before the charger is released for use by the end user. The commissioning may include verification of subsystems within the charger. For example, communication between the charger and the vendor or manufacturer may be verified during commissioning so that operation of the charger may be monitored remotely. Additionally, operation of power electronics and power distribution within and out of the charger may be verified during commissioning. A human may be part of the commissioning process and the human may supply information during the commissioning process. For example, the human may input the charger’s physical location and the human may answer questions regarding the electrical infrastructure that supplies electric power to the charger. However, the human may not have knowledge of the electrical infrastructure’s capabilities and the human may not be able to provide a precise location of the charger. Therefore, commissioning of the charger may not be as through as may be desired.

The background above is provided to introduce in simplified form a selection of concepts that are further described in the detailed description. It is not meant to identify key features of the claimed subject matter, the scope of which is defined by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle and vehicle charger;

FIG. 2 is a schematic view showing how trilateration may be applied to determine a geographical location of a vehicle charger is shown;

FIG. 3 is a schematic view showing how BLE and/or Wi-Fi may be applied to determine a geographical location of a vehicle charger is shown; and

FIG. 4 is a method for commissioning a vehicle charger.

### DETAILED DESCRIPTION

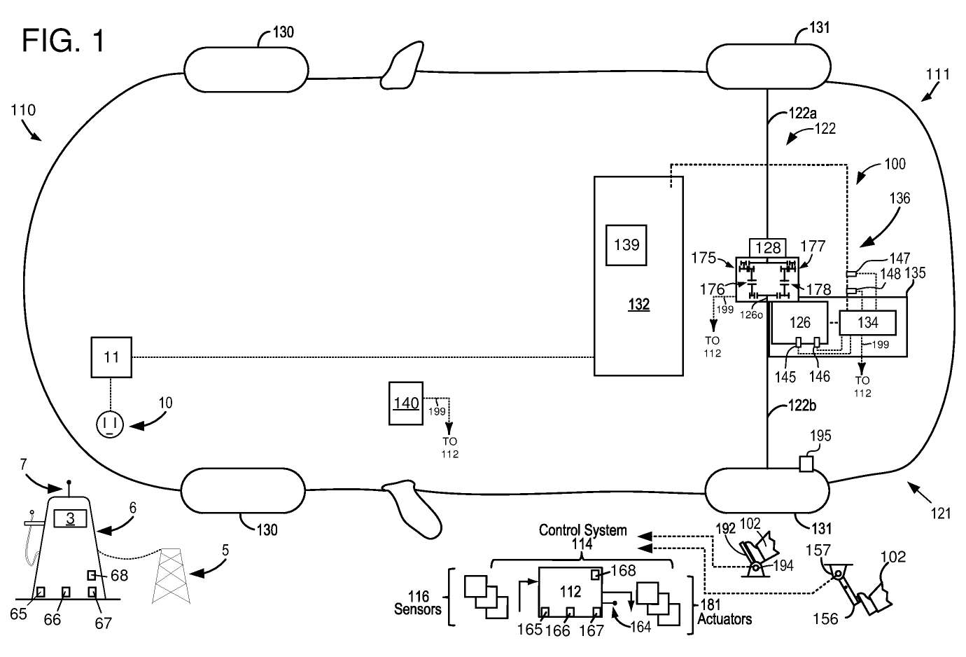

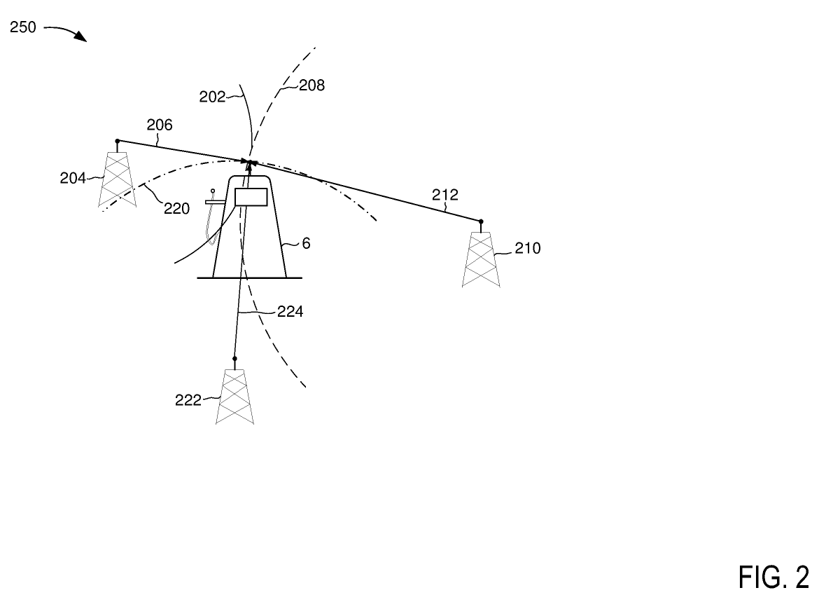

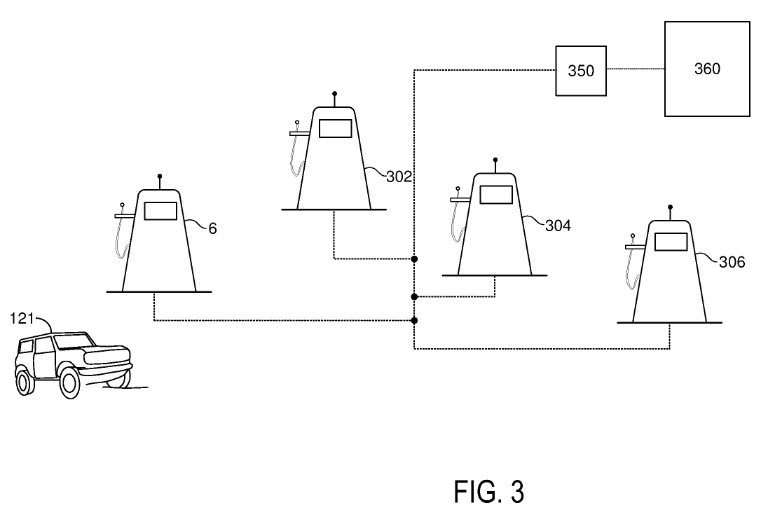

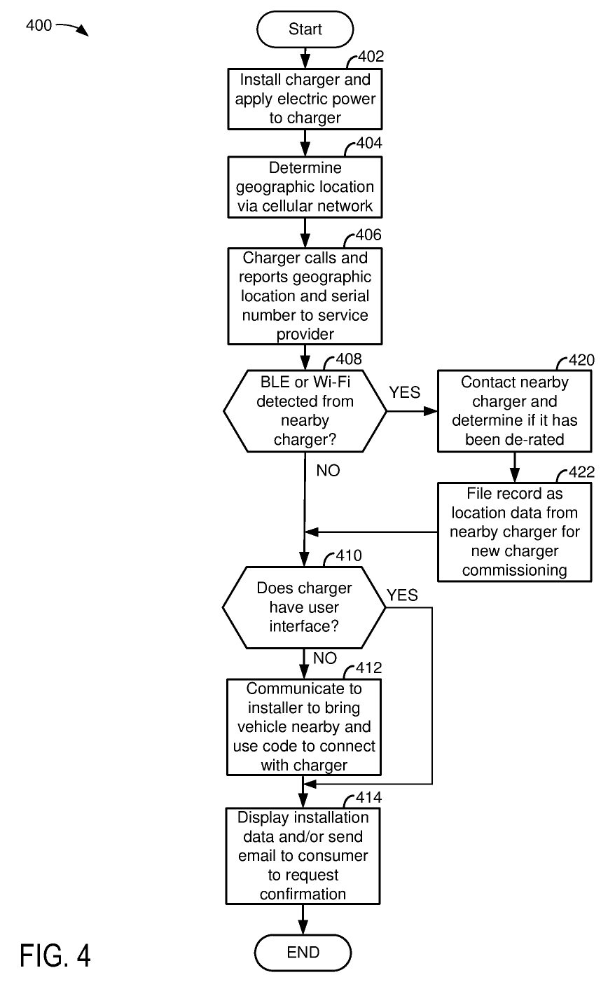

The present description is related to a method and system for commissioning a vehicle charger. The commissioning may be initiated automatically without user input when the charger is powered up a first time after being manufactured. The charger may be configured to charge an electric vehicle as shown in FIG. 1, or alternatively a hybrid vehicle. The charger may be geographically located via cellular phone towers as shown in FIG. 2. Alternatively, or in addition, the charger may be geographically located via other chargers that have already been installed and commissioned as shown in FIG. 3. The charger may be commissioned according to the method of FIG. 4.

A manufacturer or retailer of a vehicle charger may wish to automatically commission a vehicle charger so that there may be a possibility of fewer errors occurring during commissioning of the vehicle charger and so that manual labor to install the charger and its financial expense may be reduced. Additionally, an installation crew may not be aware of power grid system limitations. Further, by automatically commissioning a vehicle charger it may be possible to get user billing, user services, and warranties activated sooner.

The inventors herein have recognized the above-mentioned issues and have developed a vehicle charger, comprising: one or more controllers including executable instructions that cause the vehicle charger to: automatically in response to electric power being applied to the vehicle charger, communicate with a remote device, communicate a geographic location of the vehicle charger as determined from a cellular network to the remote device, and communicate an identification code to the remote device.

By communicating with a remote device via a vehicle charger, it may be possible to reduce a possibility of generating errors when commissioning a vehicle charger. For example, a location of the vehicle charger may be determined via a vehicle charger and cellular phone network and/or Bluetooth or WiFi wireless communications. The vehicle charger location may be submitted to a vehicle charger manufacturer or retailer by the vehicle charger without a possibility of a human mistyping a geographical address to commission the vehicle charger. Further, the geographical location may be a basis for controlling vehicle charger output so that vehicle charger output may be matched with local electrical grid capabilities.

The present description may provide several advantages. In particular, the approach may reduce a possibility of inputting errors when activating a vehicle charger. Further, the approach may speed up activation time of a vehicle charger so that charger services may be on-line sooner. Additionally, the approach provides ways of commissioning vehicle chargers that have fewer functional capabilities.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a schematic diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout the description of FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126o of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle’s kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle caliper control pedal 156.

Electric energy storage device 132 may periodically receive electric power via power converter 12 and receptacle 11. Receptacle 11 may receive electric power from a vehicle charger 6 and vehicle charger 6 is remote from vehicle 121. Vehicle charger 6 may wirelessly communicate with vehicle 121 via transceiver 7 and vehicle charger 6 may include an optional human/machine interface 3 (e.g., display and/or keyboard). Vehicle charger 6 may receive electric power from a stationary power grid 5. Vehicle charger 6 includes non-transitory (e.g., read exclusive memory) 65, random access memory 66, digital inputs/outputs 68, and a microcontroller 67. Microcontroller 67 may send and receive messages via transceiver 7. As a non-limiting example, driveline 100 may be configured as a plug-in electric vehicle (EV), whereby electrical energy may be supplied to electric energy storage device 132 via the power grid (not shown). Alternatively, vehicle 121 may be a plug-in hybrid vehicle.

Electric energy storage device 132 includes an electric energy storage device controller 139. Electric energy storage device controller 139 may provide charge balancing between energy storage element (e.g., battery cells) and communication with other vehicle controllers (e.g., controller 112).

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 and power distribution module 138 via network 199 (e.g., a controller area network (CAN) or an Ethernet network). Controller 112 may communicate with vehicle charger 10 via transceiver 164.

Thus, the system of FIG. 1 provides for a vehicle charger, comprising: one or more controllers including executable instructions that cause the vehicle charger to: automatically in response to electric power being applied to the vehicle charger, communicate with a remote device, communicate a geographic location of the vehicle charger as determined from a cellular network to the remote device, and communicate an identification code to the remote device. In a first example, the vehicle charger further comprises additional executable instructions that cause the one or more controllers to determine the geographic location from cellular network data. In a second example that may include the first example, the vehicle charger includes where the one or more controllers determine the geographic location based on locations of cellular network towers. In a third example that may include one or both of the first and second examples, the vehicle charger includes where the one or more controllers determine the geographic location based on sending a signal to the cellular network towers. In a fourth example that may include one or more of the first through third examples, the vehicle charger further comprises additional executable instructions that cause the one or more controllers to request a geographical location of the vehicle charger from the cellular network. In a fifth example that may include one or more of the first through fourth examples, the vehicle charger further comprises additional executable instructions that cause the one or more controllers to provide a prompt to move a vehicle to within a threshold distance of the vehicle charger to continue commissioning of the vehicle charger. In a sixth example that may include one or more of the first through fifth examples, the vehicle charger further comprises additional executable instructions that cause the one or more controllers to permit charge to be delivered from the vehicle charger to a vehicle in response to the remote device acknowledging that the vehicle charger is commissioned.

The system of FIG. 1 also provides for a vehicle charger, comprising: one or more controllers including executable instructions that cause the vehicle charger to: automatically in response to electric power being applied to the vehicle charger, communicate with a remote device, communicate a geographic location of the vehicle charger based on a network node of one or more other vehicle chargers to the remote device, and communicate an identification code to the remote device. In a first example, the vehicle charger further comprises additional executable instructions that cause the one or more controllers to receive input for commissioning the vehicle charger from a vehicle. In a second example that may include the first example, the vehicle charger includes where the vehicle is remote from the vehicle charger, and where commissioning the vehicle charger includes enabling charge to be supplied to the vehicle or a second vehicle via the vehicle charger. In a third example that may include one or both of the first and second examples, the vehicle charger includes where the vehicle communicates with the vehicle charger via Bluetooth or WiFi. In a fourth example that may include one or more of the first through third examples, the vehicle charger further comprises receiving input via the vehicle charger for commissioning the vehicle charger.

Referring now to FIG. 2, a simplified graphic representation of a way to determine a geographical location of vehicle charger 6 is shown. In this example, cellular antennas are represented as a single point in the graphic representation, but in practice, cellular network antennas may be arranged in triangular arrays. FIG. 2 shows three cellular phone network towers (204, 210, and 222) and vehicle charger 6.

Each cellular phone network tower shown in FIG. 2 may send out a signal and the signal travels a distance to the vehicle charger 6 that is represented by a vector that is represented by an arrow (206, 212, and 224). Arcs are shown associated with each cellular phone network tower, and the arcs represent regions where the location of the vehicle charger may be based solely on the distance measured between the respective cellular phone network tower and the vehicle charger. For example, a distance between cellular network tower 204 and vehicle charger may be determined by cellular network tower 204 sending out a signal to the vehicle charger and the amount of time it takes for the vehicle charger 6 to respond to the signal. The amount of time it takes vehicle charger 6 to respond to the signal may be indicative of the distance that is represented by arrow 206.

With the determined distance from cellular network tower 204 to vehicle charger being equal to the length of arrow 206, the geographical location of vehicle charger 6 using just the distance indicated by arrow 206 may be determined to be somewhere along the length of arc 202. The distance of arc 202 may be relatively large, but since there are two nearby cellular network towers (222 and 210), these two cellular network towers may determine their respective distances to vehicle charger 6 by measuring an amount of time it takes vehicle charger 6 to respond to a request. The distance from cellular network tower 222 to vehicle charger is indicated by arrow 224 and the distance from cellular network tower 210 to vehicle charger 6 is indicated by arrow 212. The location of vehicle charger 6 based on the distance from cellular network tower 222 to vehicle charger 6 may be determined to be somewhere along arc 220 using just the distance indicated by arrow 224. The location of vehicle charger 6 based on the distance from cellular network tower 210 to vehicle charger 6 may be determined to be somewhere along arc 208 using just the distance indicated by arrow 212. However, by determining the intersection of arcs 202, 220, and 208, the location of vehicle charger 6 may be determined. Vehicle charger 6 may make an inquiry of its present location from cellular phone network 250, which comprises cellular network towers 204, 210, and 222. The cellular phone network 250 may report the geographical location of vehicle charger 6 by applying trilateration, or alternatively, triangulation to determine the position of vehicle charger 6.

Turning now to FIG. 3, a vehicle charger network 300 is shown. In this example, vehicle charger network 300 comprises four chargers (6, 302, 304, and 306), but it may be appreciated that a vehicle charger network may be comprised of more than or less than four chargers. In this example, the vehicle chargers are part of a linked computer network 350. Linked computer network 350 may be wired or wireless and it may be assigned a network node identification number or code. Vehicle 121 may wirelessly communicate with one or more of vehicle chargers. Further, vehicle 121 may operate as a terminal for data entry into the one or more vehicle chargers. In one example, vehicle 121 may display questions and request input from commissioning personnel, and vehicle 121 may relay commissioning input back to vehicle charger 6. Vehicle charger 6 may supply commissioning data to computer network 350 and cloud server 360. The cloud server 360 may be considered as a controller.

Moving on to FIG. 4, a method for commissioning a vehicle charger is shown. At least portions of method of FIG. 4 may be included as executable instructions stored in non-transitory memory of the system of FIG. 1, while other portions of the method of FIG. 4 may be performed via a human. The portions of the method of FIG. 4 that are performed via a controller may reside in a single controller, or alternatively, in two or more controllers.

At 402, method 400 includes installing a vehicle charger and applying electric power to the vehicle charger. The vehicle charger may be electrically coupled to a power grid that supplies alternating current (AC) to the vehicle charger. Method 400 proceeds to 404.

At 404, method 400 includes determining a geographic location of the vehicle charger via a cellular phone network. In one example, the vehicle charger may send a signal and query the cellular phone network for the vehicle charger’s geographical location. The cellular phone network may apply triangulation or trilateration to determine the geographical location of the vehicle charger based on the geographical locations of the cellular network antennas and/or towers. The cellular phone network may reply to the vehicle charger the vehicle charger’s geographical location. Alternatively, the vehicle charger may utilize data from a global positioning system to determine its geographical location. In still other examples, the vehicle charger may determine its own location by sending a signal and pinging cellular phone network antenna towers and the locations of the cellular phone network towers. The vehicle charger’s geographical location may be associated with a customer account for providing charging services. Method 400 proceeds to 406.

At 406, method 400 calls or uses the cellular phone network to contact a remote server and the vehicle charger provides its geographical location to the remote server. The vehicle charger may also supply the remote server with other data including an identification code or number for the vehicle charger that is being commissioned. Further, the vehicle charger may provide data representing state of internal components within the vehicle charger. For example, the vehicle charger may provide operating states of circuit breakers or fuses. Method 400 proceeds to 408.

At 408, method 400 judges whether or not the vehicle charger that is being commissioned senses an operational and accessible Bluetooth low energy (BLE) or WiFi network. A BLE or WiFi network that supports similar vehicle chargers that have been commissioned may allow communication between nearby similarly situated vehicle chargers. If method 400 detects a BLE or WiFi network that may be accessed and that includes other vehicle chargers, the answer is yes and method 400 proceeds to 420. Otherwise, the answer is no and method 400 proceeds to 410.

At 420, method 400 contacts one or more nearby vehicle chargers via the BLE or WiFi and retrieves initial data and control parameters for commissioning the vehicle charger that is being commissioned. At least some data and control parameters from a nearby vehicle charger may be applied to the vehicle charger that is being commissioned. For example, method 400 may retrieve power grid power supply limits or constraints from a nearby vehicle charger that may be applied to de-rate or reduce an electric charge delivery capacity of the vehicle charger that is being commissioned according to power grid supply constraints. If the nearby vehicle charger has been de-rated (e.g., its output power has been constrained to be less than its maximum output power), the vehicle charger that is being commissioned may be de-rated based on control parameters and commissioning data that is received from the nearby vehicle charger. Further, method 400 may determine a geographical location of the computer network that links multiple vehicle chargers from a network node number. Method 400 proceeds to 422.

At 422, for a new vehicle charger commissioning, method 400 may file a record as location data that has been learned from a nearby vehicle charger. The file record may be stored at a remote cloud server. Method 400 proceeds to 410.

At 410, method 400 judges whether or not the vehicle charger that is being commissioned is a level 3 vehicle charger (e.g., a direct current (DC) fast charger). If so, the answer is yes and method 400 proceeds to 414. Otherwise, the answer is no and method 400 proceeds to 412.

At 412, method 400 communicates to the vehicle charger installer to bring a vehicle nearby (e.g., within a threshold distance (less than 3 meters)) and input a one-time use code to connect the vehicle to the vehicle charger that is being commissioned. A level 2 charger may include a display to output text messaged, but it may lack facilities (e.g., a key pad) to receive input from a human. Method 400 proceeds to 414.

At 414, method 400 displays information on a human/machine interface whether the human/machine interface is in a vehicle or part of the vehicle charger. The displayed information may request confirmation and/or input to determine applicable control parameters. The vehicle charger that is being commissioned receives the data that is input by a human via the human/machine interface. Once receipt of commissioning data and confirmation of vehicle charger configuration is confirmed at the vehicle charger and/or at the vehicle, an email is sent to a customer account for approval to apply the vehicle charger commissioning control parameters as previously received. Once the customer approves the commissioning setup and control parameters, the cloud server may activate the vehicle charger and allow the vehicle charger to deliver AC or DC power to vehicles. The vehicle charger may be manufactured such that it will not output electric power to a vehicle unless it has been commissioned and customer approval is received. The vehicle charger may be activated via closing contactors within the vehicle charger that has been commissioned to allow electric power to flow through the vehicle charger. Method 400 proceeds to exit.

In this way, method 400 determines commissioning data and may send the commissioning data to a remote server. If a customer account has been set up for the vehicle charger, and if the vehicle’s charger geographical location has been determined and sent to a remote server, the vehicle charger may be activated. This commissioning procedure may help to ensure that the geographical location of the charger is accurate in case the vehicle charger requests service at a later time. Further, method 400 may reduce data entry errors and expedite vehicle charger commissioning so that the charger may begin to charge vehicles sooner.

Thus, the method of FIG. 4 provides for a method for operating a vehicle charger, comprising: communicating a first geographical location of the vehicle charger from the vehicle charger to a remote device prior to, or as part of, a commissioning the vehicle charger, where the first geographical location is based on cellular network data. In a first example, the method includes where the commissioning of the vehicle charger enables the vehicle charger to charge a vehicle, and where the vehicle charger cannot charge the vehicle prior to the commissioning. In a second example that may include the first example, the method further comprises communicating an identification code of the vehicle charger to the remote device prior to or as part of the commissioning. In a third example that may include one or both of the first and second examples, the method further comprises communicating a second geographical location of the vehicle charger from the vehicle charger to the remote device prior to, or as part of, the commissioning. In a fourth example that may include one or more of the first through third examples, the method includes where the first geographical location is based on cellular network data, and where the second geographical location is based on bluetooth or WiFi data. In a fifth example that may include one or more of the first through fourth examples, the method further comprises receiving input data for commissioning the vehicle charger from a vehicle. In a sixth example that may include one or more of the first through fifth examples, the method further comprises communicating with the vehicle via the vehicle charger as part of commissioning the vehicle charger. In a seventh example that may include one or more of the first through sixth examples, the method further comprises receiving data from one or more other vehicle chargers to commission the vehicle charger.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A vehicle charger, comprising:
one or more controllers including executable instructions that cause the vehicle charger to: automatically in response to electric power being applied to the vehicle charger, communicate with a remote device, communicate a geographic location of the vehicle charger as determined from a cellular network to the remote device, and communicate an identification code to the remote device.

2. The vehicle charger of claim 1, further comprising additional executable instructions that cause the one or more controllers to determine the geographic location.

3. The vehicle charger of claim 2, where the one or more controllers determine the geographic location based on geographical locations of cellular network towers or computer network data.

4. The vehicle charger of claim 3, where the one or more controllers determine the geographic location based on sending a signal to the cellular network towers.

5. The vehicle charger of claim 1, further comprising additional executable instructions that cause the one or more controllers to request a geographical location of the vehicle charger from the cellular network.

6. The vehicle charger of claim 1, further comprising additional executable instructions that cause the one or more controllers to provide a prompt to move a vehicle to within a threshold distance of the vehicle charger to continue commissioning of the vehicle charger.

7. The vehicle charger of claim 1, further comprising additional executable instructions that cause the one or more controllers to permit charge to be delivered from the vehicle charger to a vehicle in response to the remote device acknowledging that the vehicle charger is commissioned.

8. A method for operating a vehicle charger, comprising:
communicating a first geographical location of the vehicle charger from the vehicle charger to a remote device prior to, or as part of, a commissioning the vehicle charger, where the first geographical location is based on cellular network data.

9. The method of claim 8, where the commissioning of the vehicle charger enables the vehicle charger to charge a vehicle, and where the vehicle charger cannot charge the vehicle prior to the commissioning.

10. The method of claim 9, further comprising communicating an identification code of the vehicle charger to the remote device prior to or as part of the commissioning.

11. The method of claim 10, further comprising communicating a second geographical location of the vehicle charger from the vehicle charger to the remote device prior to, or as part of, the commissioning.

12. The method of claim 11, where the first geographical location is based on cellular network data, and where the second geographical location is based on bluetooth or WiFi data.

13. The method of claim 8, further comprising receiving input data for commissioning the vehicle charger from a vehicle.

14. The method of claim 13, further comprising communicating with the vehicle via the vehicle charger as part of commissioning the vehicle charger.

15. The method of claim 8, further comprising receiving data from one or more other vehicle chargers to commission the vehicle charger.

16. A vehicle charger, comprising:
one or more controllers including executable instructions that cause the vehicle charger to: automatically in response to electric power being applied to the vehicle charger, communicate with a remote device, communicate a geographic location of the vehicle charger based on a network node of one or more other vehicle chargers to the remote device, and communicate an identification code to the remote device.

17. The vehicle charger of claim 16, further comprising additional executable instructions that cause the one or more controllers to receive input for commissioning the vehicle charger from a vehicle.

18. The vehicle charger of claim 17, where the vehicle is remote from the vehicle charger, and where commissioning the vehicle charger includes enabling charge to be supplied to the vehicle or a second vehicle via the vehicle charger.

19. The vehicle charger of claim 17, where the vehicle communicates with the vehicle charger via Bluetooth or WiFi.

20. The vehicle charger of claim 16, further comprising receiving input via the vehicle charger for commissioning the vehicle charger.
